(19) United States
(12) Patent Application Publication
(10) Pub. No.: US 2010/0151188 A1
(43) Pub. Date: Jun. 17, 2010

(54) STRUCTURE HAVING ORGANIC-INORGANIC COMPOSITE LAYER AND METHOD OF MANUFACTURING THE SAME

(75) Inventors: Kenichi ISHIZUKA, Kanagawa (JP); Taisei NISHIMI, Kanagawa (JP)

Correspondence Address: YOUNG & THOMPSON, 209 Madison Street, Suite 500, Alexandria, VA, 22314, US

(73) Assignee: FUJIFILM Corporation, Tokyo (JP)

(21) Appl. No.: 12/639,409

(22) Filed: Dec. 16, 2009

(30) Foreign Application Priority Data
Dec. 16, 2008 (JP) 2008-319647

(51) Int. Cl. B32B 7/00; B05D 1/18; C25D 5/02

(52) U.S. Cl. 428/119; 427/437; 205/118

(57) ABSTRACT

A structure having on a flexible substrate an organic-inorganic composite layer which contains a polymer and a metal as its main components and in which one of the components forms microdomains oriented perpendicularly to the substrate by using a microphase-separated morphology formed from a block copolymer, and a manufacturing method capable of manufacturing the structure at a low cost and over a large surface area are provided. The structure includes in order on the flexible substrate, a conductive layer; an adsorbing compound layer, and the organic-inorganic composite layer having the microphase-separated morphology which includes a polymer phase and a metal phase and in which one of the phases makes up cylindrical or lamellar microdomains oriented perpendicularly to the flexible substrate.

### BACKGROUND OF THE INVENTION

The present invention relates to a structure having a conductive layer, an adsorbing compound layer, and an organic-inorganic composite layer in this order on a flexible substrate. The present invention also relates to a method of manufacturing such a structure.

Recently, in the fields of optical materials and electronic materials, there has been a growing demand for greater integration, higher information density, and image information of higher definition. Materials and structures having been controlled for the morphology at the nanometer level are required in order to cope with such a demand. In particular, to confer flexibility, handleability and lightweight properties for bendability during use and for lamination onto curved surfaces, there is an acute desire for the high-precision and low-cost manufacture of structures (e.g., layers) having micropattern morphologies on flexible substrates such as polymer films. Of those structures having the micropattern morphologies, a structure which is obtained by using different types of materials including a metallic material and a polymer material and in which one of these materials is oriented in a specified direction is expected to exhibit such characteristics as anisotropic refractive index, anisotropic electrical conductivity, anisotropic magnetic properties, and anisotropic thermal conductivity, and to be employed in a broad range of fields including energy, the environment and the life sciences.

Micropatterning processes that have been proposed include bottom-up techniques in which a microstructure is manufactured by employing “self-assembly”—i.e., the spontaneous formation of an ordered pattern. Of such techniques, block copolymers formed by bonding two or more different types of polymer chains are known to undergo phase separation at the deca-nanometer level by self-assembly to form a so-called “microphase-separated morphology.”

A number of efforts are currently being made to manufacture structures having on flexible substrates an ordered pattern morphology in which the constituent materials are arrayed in specific directions by using the properties of the block copolymers. More specifically, attempts are being made to orient cylindrical or lamellar microdomains in a microphase-separated morphology formed from a block copolymer perpendicularly to a substrate to obtain an ordered pattern and manufacture a structure controlled for the morphology at the nanometer level by using the resulting ordered pattern.

For example, B. H. Sohn, et al. “Perpendicular lamellae induced at the interface of neutral self-assembled monolayers in thin diblock copolymer films” (Polymer, 2002, vol. 43, pp. 2507-2512) describes production of a film having an ordered pattern which involves preparing a monomolecular film of 3-(p-methoxyphenyl)propyltrichlorosilane on a silicon wafer and applying a polystyrene-methyl polymethacrylate block copolymer onto the monomolecular film.

According to JP 2004-527905 A, a microphase-separated morphology having cylindrical microdomains oriented perpendicularly to a substrate is obtained by preparing a block copolymer film on the conductor or semiconductor substrate, vapor-depositing aluminum on the prepared film and applying an electric field. In addition, JP 2004-527905 A produces an organic-inorganic composite having a metal in wire form filled therein by removing the cylindrical microdomains in the resulting microphase-separated morphology and filling a metallic material such as cobalt into the pores.

### SUMMARY OF THE INVENTION

The block copolymer film obtained in the literature of B. H. Sohn, et al. has a lamellar phase-separated morphology, a part of which is oriented perpendicularly to the substrate. However, a large part of the film has a mixed morphology of a phase-separated morphology oriented horizontally to the substrate and a phase-separated morphology oriented perpendicularly to the substrate, and the film is not satisfactory in terms of controlling the orderliness. Moreover, substrates such as silicon wafers are rigid, thus limiting applications and resulting in poor practical utility.

In addition, JP 2004-527905 A yields the microphase-separated morphology having the cylindrical microdomains oriented perpendicularly to the substrate, but application of an electric field is necessary. In such a process where an electrical field is applied, the number of operations (e.g., forming electrodes, applying a voltage) increases, creating a need for a larger apparatus. Moreover, such a process is difficult to carry out over a large surface area and is thus undesirable in terms of productivity. What is more, JP 2004-527905 A requires peeling off of vapor-deposited aluminum used for the electrode from the block copolymer layer in cases where the resulting microphase-separated morphology is employed to manufacture a structure. This process incurred a further increase in the number of steps, thus lowering the productivity.

Because sufficient study has yet to be done on controlling the orientation of the microphase-separated morphology, it has been difficult to manufacture, at a low cost and over a large surface area, microphase-separated morphologies in which the microdomains are oriented perpendicularly to a flexible substrate such as a polymer substrate. A method of simply manufacturing a composite comprising different types of materials over a large surface area by making use of the above-described microphase-separated morphology has not been found yet.

In order to solve the above-described prior art problems, an object of the present invention is to provide a structure having on a flexible substrate an organic-inorganic composite layer which contains a polymer and a metal as its main components and in which one of the components forms microdomains oriented perpendicularly to the substrate by making use of a microphase-separated morphology formed from a block copolymer. Another object of the invention is to provide a manufacturing method capable of manufacturing the structure at a low cost and over a large surface area.

The inventors of the present invention have made intensive studies and as a result found that, by inserting a layer having specific qualities between a flexible substrate such as a polymer substrate and a layer formed of a block copolymer, a block copolymer layer having an oriented structure that is ordered can be obtained more easily than by conventional methods. In addition, the phase-separated morphology of the block copolymer layer was employed to form a composite layer of a metal and a polymer and the present invention has been thus completed.

That is, the inventors of the present invention have made intensive studies and as a result found that the above objects of the present invention are achieved by the characteristic features described in (1) to (11) below.

(1) A structure comprising in order on a flexible substrate:

a conductive layer;

an adsorbing compound layer formed of a compound having a group which is adsorbable onto the conductive layer; and

an organic-inorganic composite layer having a microphase-separated morphology which includes a polymer phase and a metal phase and in which one of the phases makes up cylindrical or lamellar microdomains oriented perpendicularly to the flexible substrate.

(2) The structure of (1), wherein the adsorbing compound layer has a thickness which is equal to or larger than a surface roughness Ra of the conductive layer.

(3) The structure of (1) or (2), wherein the adsorbing compound layer is a layer formed of a compound represented by general formula (1):

X—L—R (1)

wherein R is a hydrogen atom, an optionally branched alkyl group or an alkoxy group, L is a divalent linkage group or merely a bond, X is a thiol group, an amino group, a selenol group, a nitrogen-containing heterocyclic group, an asymmetric or symmetric disulfide group, a sulfide group, a diselenide group, a selenide group or —Si(R¹)ₘ(Y)ₙ, R¹ is a hydrogen atom or an alkyl group of 1 to 6 carbon atoms, Y is a hydrolyzable group, and the letter m is an integer from 0 to 2 and the letter n is an integer from 1 to 3, such that n+m=3.
(4) The structure of any one of (1) to (3), wherein the conductive layer is a layer comprising at least one metal or semimetal selected from the group consisting of gold, platinum, silver, copper, iron, silicon, nickel, lead, indium, chromium, tin, titanium, zinc, gallium, bismuth, zirconium and aluminum, or an oxide thereof.
(5) The structure of any one of (1) to (4), wherein a metal making up the metal phase of the organic-inorganic composite layer is at least one metal selected from the group consisting of copper, silver, gold, aluminum and nickel.
(6) The structure of any one of (1) to (5), wherein the flexible substrate is a polymer substrate.
(7) The structure of any one of (1) to (6), wherein a polymer making up the polymer phase of the organic-inorganic composite layer is a polymer selected from the group consisting of polystyrene, polymethyl methacrylate, polybutadiene, polyisoprene and polyethylene oxide.
(8) A method of manufacturing a structure comprising:

a step 1 for forming a conductive layer on a flexible substrate;

a step 2 for forming an adsorbing compound layer on the conductive layer using an adsorbing compound;

a step 3 for forming on the adsorbing compound layer a block copolymer layer made of a block copolymer and having a microphase-separated morphology in which one of phases is a lamellar or cylindrical phase oriented perpendicularly to the flexible substrate;

a step 4 for removing one of the phases in the microphase-separated morphology after the step 3; and

a step 5 for filling a region of the removed phase with a metal after the step 4.

(9) The method of (8), wherein the step 5 is a step of depositing the metal in the region of the removed phase by electrolytic plating or electroless plating.
(10) The method of (8) or (9), wherein the step 3 is a step of forming the block copolymer layer by coating the adsorbing compound layer with a solution containing the block copolymer.
(11) The method of any one of (8) to (10), wherein one of two types of polymer chains making up the block copolymer is a polymer chain selected from the group consisting of polystyrene, polymethyl methacrylate, polybutadiene, polyisoprene and polyethylene oxide.

This invention can provide a structure having on a flexible substrate an organic-inorganic composite layer which contains a polymer and a metal as its main components and in which one of the components forms microdomains oriented perpendicularly to the substrate by making use of a microphase-separated morphology formed from a block copolymer, as well as a manufacturing method capable of manufacturing the structure at a low cost and over a large surface area.

### BRIEF DESCRIPTION OF THE DRAWINGS

FIG. 1A is a perspective, cross-sectional view showing a structure having a cylindrical microphase-separated morphology according to one embodiment of the present invention, and FIG. 1B is a top view of the same;

FIG. 2A is a perspective, cross-sectional view showing a structure having a lamellar microphase-separated morphology according to another embodiment of the present invention, and FIG. 2B is a top view of the same;

FIGS. 3A to 3E are schematic cross-sectional views showing a substrate and each layer in the order of steps of a method of manufacturing the structure of the present invention;

FIG. 4 is an atomic force microscopy image taken from the top side of Specimen A;

FIG. 5 is an atomic force microscopy image taken from the top side of Specimen B;

FIG. 6 is an atomic force microscopy image taken from the top side of Specimen C;

FIG. 7 is a conductive atomic force microscopy image taken from the top side of Specimen C;

FIG. 8 shows the results of current-voltage (I-V) measurement of Specimen C; and

FIG. 9 is an atomic force microscopy image taken from the top side of Specimen F.

### DETAILED DESCRIPTION OF THE INVENTION

The structure of the present invention is described below in detail based on preferred embodiments shown in the accompanying drawings.

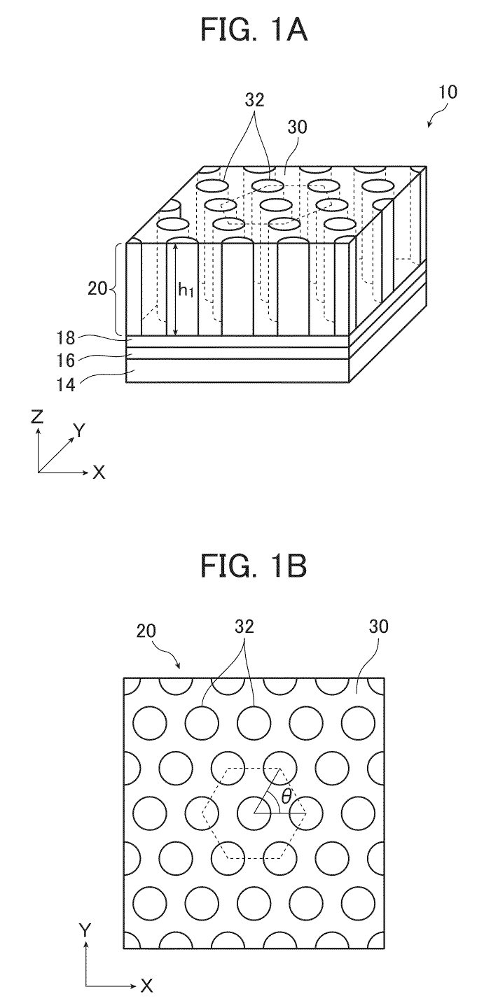

FIG. 1A is a perspective, cross-sectional view showing a structure (also referred to herein as a “multilayer body”) according to one embodiment of the present invention.

A structure 10 shown in FIG. 1A has a layered structure in which a conductive layer 16, an adsorbing compound layer 18, and an organic-inorganic composite layer 20 are deposited on a flexible substrate 14 in this order. As shown in FIG. 1A, the organic-inorganic composite layer 20 has a cylindrical microphase-separated morphology including a continuous phase 30 composed of a polymer phase and cylindrical microdomains 32 distributed within the continuous phase 30 and composed of a metal phase, and the cylindrical microdomains 32 are oriented perpendicularly with respect to the flexible substrate 14. The present invention is not limited to the embodiment shown in FIG. 1A, and the continuous phase 30 and the cylindrical microdomains 32 in FIG. 1A may be composed of a metal phase and a polymer phase, respectively. In terms of anisotropic electrical conductivity and optical anisotropy, a morphology including the cylindrical microdomains 32 composed of a metal and the continuous phase 30 composed of a polymer is preferably used.

In FIG. 1A, the cylindrical microdomains 32 are filled with a metal or the like from the upper side surface of the organic-inorganic composite layer 20 to the bottom surface on the substrate 14 side, but the amount of filling is not particularly limited and the cylindrical microdomains may be filled with the metal or the like up to the height which is half the thickness of the organic-inorganic composite layer 20.

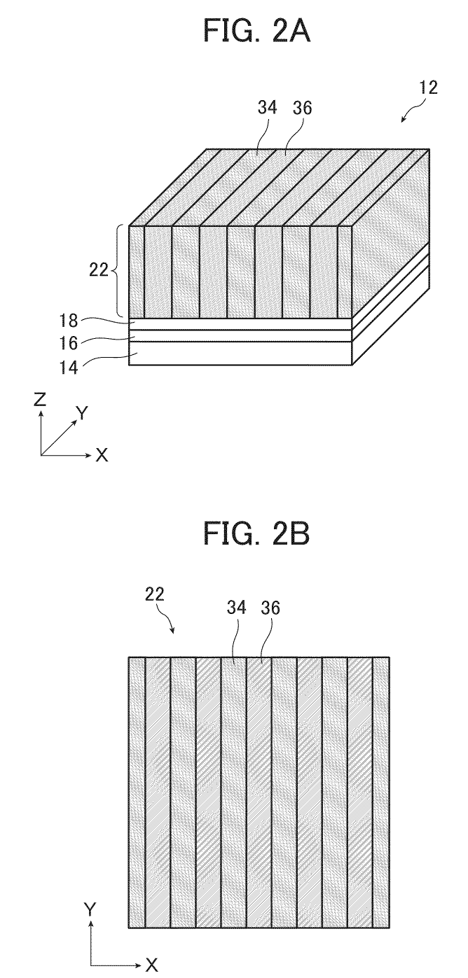

FIG. 2A is a perspective, cross-sectional view showing a structure according to another embodiment of the present invention.

A structure 12 shown in FIG. 2A has a layered structure in which a conductive layer 16, an adsorbing compound layer 18, and an organic-inorganic composite layer 22 are deposited on a flexible substrate 14 in this order. In FIG. 2A, the organic-inorganic composite layer 22 forms a lamellar microphase-separated morphology including lamellar phases 34 and 36, which are oriented perpendicularly with respect to the flexible substrate 14. In FIG. 2A, the lamellar phases 34 and 36 are composed of a polymer phase and a metal phase, respectively.

The flexible substrate 14, conductive layer 16, and adsorbing compound layer 18 in the structure 10 shown in FIGS. 1A and 1B are the same components as those in the structure 12 shown in FIGS. 2A and 2B. FIGS. 1A, 1B, 2A and 2B do not limit the thicknesses of the flexible substrate 14, conductive layer 16, adsorbing compound layer 18 and organic-inorganic composite layers 20 and 22.

Each of the flexible substrate 14, conductive layer 16, adsorbing compound layer 18 and organic-inorganic composite layers 20, 22 making up the structures of the present invention is first described.

### Flexible Substrate

The flexible substrate 14 of the present invention supports the subsequently described conductive layer 16, adsorbing compound layer 18 and organic-inorganic composite layer 20 or 22 deposited thereon and is not particularly limited as long as it is flexible.

Illustrative examples include substrates of polymers such as polyimide (PI), polyethersulfone (PES), polymethyl methacrylate (PMMA), polycarbonate (PC), cycloolefin polymer (COP), polyethylene naphthalate (PEN), polyethylene terephthalate (PET), polypropylene (PP), liquid-crystal polymer (LCP), polydimethylsiloxane (PDMS) and triacetyl cellulose (TAC); and metal films such as copper foil and aluminum foil. Of these, polymer substrates are preferred on account of their easy processability and good handleability. Substrates of polyimide, polyethylene naphthalate and polyethylene terephthalate are especially preferred because of their high heat resistance, excellent solvent resistance and good mechanical strength.

The flexible substrate 14 may optionally be subjected to, for example, a known corona discharge treatment in order to strengthen their adhesion to the subsequently described conductive layer 16.

### Conductive Layer

The conductive layer 16 of the present invention is a layer made of a conductive substance which is formed on the upper side of the flexible substrate 14 to impart electrical conductivity to the structure (multilayer body). This conductive layer also serves as the plating nucleus in the electrolytic plating and electroless plating to be described below.

The conductive layer 16 is preferably a layer formed of at least one metal or semimetal selected from the group consisting of gold, platinum, silver, copper, iron, silicon, nickel, lead, indium, chromium, tin, titanium, zinc, gallium, bismuth, zirconium and aluminum, or an oxide thereof (metal oxide or semimetal oxide). Of these, copper, silver, gold, platinum, iron or oxides thereof and ITO are preferably used in terms of low resistance. The conductive layer 16 may be made of a single conductive substance or a combination of two or more conductive substances.

The conductive layer 16 in the present invention may be a monolayer formed by one of the above-mentioned materials, a monolayer made of two or more of the above materials, or a multilayer formed by stacking a plurality of such monolayers.

The conductive layer 16 preferably has a thickness of 10 to 500 nm and more preferably 10 to 200 nm although the layer thickness may be set as appropriate for the intended purpose of the structure. If the conductive layer is too thin, the surface of the flexible substrate 14 cannot be covered completely and uniformly. On the other hand, if the conductive layer is too thick, cracking or delamination will occur between the substrate and the conductive layer 16. Neither situation is desirable.

It is preferable for the conductive layer 16 formed on the flexible substrate 14 to be as smooth as possible (to have a surface roughness Ra of 0) in terms of capability to form the adsorbing compound layer 18 to be described below more uniformly. More specifically, the surface roughness Ra is preferably 5 nm or less, more preferably 2 nm or less and even more preferably 1.5 nm or less. The surface roughness Ra is most preferably 0 nm. As used herein, “roughness” refers to the roughness Ra (mean surface roughness) value determined by conducting a roughness analysis on atomic force microscope topographic images measured with a conventional, commercially available atomic force microscope (also abbreviated below as “AFM”).

### Adsorbing Compound Layer

The adsorbing compound layer 18 of the present invention is formed on the conductive layer 16 to control the orientation of the microphase-separated morphology of the organic-inorganic composite layer 20 or 22 to be described later.

The adsorbing compound layer 18 is a layer formed of a compound which has at least one functional group exhibiting adsorptive properties on the conductive layer (adsorbing group on conductive layer). The “adsorbing group” refers to a group which is adsorbable on the conductive layer and illustrative examples thereof include silyl group, thiol group, sulfide group, disulfide group, amino group, phosphonate group, phosphino group, cyano group, isocyano group, carboxy group, selenol group, nitrogen-containing heterocyclic group, alkene group, trivalent phosphate compound-derived group, selenide group, diselenide group, isonitrile group, nitro group, isothiocyanate group, xanthate group, thiocarbamate group, thionic acid group and dithionic acid group. Of these, a compound having at least one adsorbing group selected from the group consisting of silyl group, thiol group, sulfide group, disulfide group, amino group, phosphino group and selenol group is preferably used.

A so-called self-assembled monolayer (hereinafter also abbreviated as “SAM”) is preferably used as the layer formed of a compound having such an adsorbing group. SAM is a monomolecular layer in which material molecules assemble together at the surface of a target (interface between a solid and a liquid or interface between a solid and a gas) and autonomically build up to take a structure where the material molecules are regularly arrayed. The compound having an adsorbing group in the present invention has a structure in which the adsorbing group adsorbs on and binds to the conductive layer 16 whereas the other molecular chain moieties extend outward from the conductive layer 16.

A preferred example of the adsorbing group-containing compound includes a compound represented by general formula (1):

X—L—R (1)

wherein R is a hydrogen atom, an optionally branched alkyl group or an alkoxy group, L is a divalent linkage group or merely a bond, X is a thiol group, an amino group, a selenol group, a nitrogen-containing heterocyclic group, an asymmetric or symmetric disulfide group, a sulfide group, a diselenide group, a selenide group or —Si(R¹)ₘ(Y)ₙ, R⁻¹ is a hydrogen atom or an alkyl group of 1 to 6 carbon atoms, Y is a hydrolyzable group, the letter m is an integer from 0 to 2 and the letter n is an integer from 1 to 3, such that n+m=3.

In general formula (1), R is a hydrogen atom, an optionally branched alkyl group or an alkoxy group. The alkyl group is not subject to any particular limitation and preferably contains 1 to 20 carbon atoms and more preferably 1 to 18 carbon atoms. Illustrative examples thereof include methyl group, ethyl group, propyl group and isopropyl group. The alkoxy group is not subject to any particular limitation and preferably contains 1 to 3 carbon atoms. Illustrative examples thereof include methoxy group, ethoxy group and propoxy group.

In general formula (1), L is a divalent linkage group or merely a bond. Illustrative examples include alkylene groups (of preferably 1 to 20 carbon atoms and more preferably 3 to 18 carbon atoms in terms of packing of molecules of the SAM material and surface uniformity (flattening), which may be linear, cyclic, branched or heterosubstituted), —O—, —S—, arylene groups, —CO—, —NH—, —SO₂—, —COO—, —CONH— and groups that are combinations thereof. Of these, alkylene groups, arylene groups or combinations thereof are preferably used. In cases where L represents merely a bond, the R moiety in general formula (1) is directly linked to X.

In general formula (1), X is a thiol group (—SH), an amino group (—NH₂), a nitrogen-containing heterocyclic group, a selenol group (—SeH), an asymmetric or symmetric disulfide group (—SS— L′-R′), a sulfide group (—S-L′-R′), a diselenide group (—SeSe— L′-R′), a selenide group (—Se-L′-R′) or a group represented by —Si(R¹)ₘ(Y)ₙ. More specific examples of the group represented by —Si(R¹)ₘ(Y), include trimethoxysilyl group (—Si(OCH₃)₃), trichlorosilyl group (—SiC1₃), alkyldimethoxysilyl group (—Si(R¹)(OCH₃)₂), dimethoxyhydrosilyl group (—Si(H)(OCH₃)₂), alkyldichlorosilyl group (—Si(R¹)Cl₂), dichlorohydrosilyl group (—Si(H)Cl₂), dialkylmonomethoxysilyl group (—Si(R¹)₂(OCH₃)), monomethoxydihydrosilyl group (—Si(H)₂(OCH₃)), dialkylmonochlorosilyl group (—Si(R¹)₂Cl), and monochlorodihydrosilyl group (—Si(H)₂Cl).

Of these, trimethoxysilyl group, trichlorosilyl group, methyldimethoxysilyl group, dimethoxyhydrosilyl group, methyldichlorosilyl group, dichlorohydrosilyl group, dimethylmonomethoxysilyl group, monomethoxydihydrosilyl group, dimethylmonochlorosilyl group, monochlorodihydrosilyl group, thiol group and amino group are preferred.

L′ and R′ in the disulfide group, sulfide group, diselenide group and selenide group are defined in the same manner as L and R in general formula (1). L′ and L may be the same or different, and R′ and R may also be the same or different.

R¹ is a hydrogen atom or an alkyl group of 1 to 6 carbon atoms, R¹ is preferably an alkyl group of 1 to 3 carbon atoms (methyl, ethyl or propyl which may be branched). In cases where there are a plurality of R¹ moieties, the R¹ moieties may be the same or different.

Y is a hydrolyzable group. Illustrative examples include alkoxy groups (e.g., methoxy, ethoxy), halogen atoms (fluorine atom, chlorine atom, bromine atom, iodine atom), and acyloxy groups (e.g., acetoxy, propanoyloxy). Of these, methoxy group, ethoxy group and chlorine atom are preferred because of the good reactivity they confer. In cases where there are a plurality of Y moieties, the Y moieties may be the same or different.

Also, the letter m is an integer from 0 to 2 and the letter n is an integer from 1 to 3, such that n+m=3. The letter m is preferably 1 or 2, and the letter n is preferably 1 or 2.

Illustrative examples of the adsorbing group-containing compound include methoxyphenylpropyltrimethoxysilane, methoxyphenylpropyltrichlorosilane, methoxyphenylpropylmethyldimethoxysilane, methoxyphenylpropylmethyldichlorosilane, octadecyltrimethoxysilane, hexadecyltrimethoxysilane, hexanethiol, octanethiol, dodecanethiol, hexadecanethiol, octadecanethiol, hexylamine, octylamine, dodecylamine, hexadecylamine, methoxyphenylethylamine, dihexyl disulfide, dioctyl disulfide, didodecyl disulfide, diisoamyl disulfide, didecyl sulfide, hexaneselenol, hexadecaneselenol, and dimethyl diselenide.

In the present invention, the adsorbing compound layer 18 might contribute to control of the orientation of the organic-inorganic composite layer 20 or 22 deposited thereon and serve to alleviate the effects of the surface roughness Ra of the conductive layer 16. In terms of more improved orientation of the domains in the organic-inorganic composite layer 20 or 22, the adsorbing compound layer 18 preferably has a thickness which is equal to or larger than the surface roughness Ra of the conductive layer 16. The thickness of the adsorbing compound layer 18 can be increased by using a compound having an adsorbing group with a longer molecular chain length, and decreased by using a compound having an adsorbing group with a shorter molecular chain length. The layer thickness can be measured by a technique such as cross-sectional TEM analysis. A simple method that may be used for estimating the layer thickness is molecular computation with a program such as MOPAC (e.g., WinMOPAC (Ver. 3.9.0)).

The adsorbing compound layer 18 preferably has a thickness which is equal to or larger than the surface roughness Ra of the conductive layer 16 as described above. More specifically, the thickness of the adsorbing compound layer 18 is preferably at least 0.5 nm, more preferably at least 1 nm and even more preferably at least 2 nm. More specifically, the thickness is preferably 0.5 nm to 10 nm. Within the above range, a cylindrical or lamellar microphase-separated morphology having a more ordered array can be obtained in the organic-inorganic composite layer 20 or 22.

The contact angle of the adsorbing compound layer 18 with water can be controlled by means of, for example, the adsorbing group-containing compound used. An optimal value is suitably selected based on the type of block copolymer described subsequently. To obtain a micropattern having a greater degree of order, the contact angle is preferably from 50 to 120° , and more preferably from 55 to 115°. “Contact angle” refers herein to the static contact angle, which is measured by the sessile drop method at 22° C. using a contact angle goniometer. As used herein, “static contact angle” refers to the contact angle under conditions where changes in state associated with time due to flow or the like do not arise.

In terms of obtaining a micropattern having a greater degree of order, it is desirable for the respective components of the block copolymer described below to have surface tensions with the adsorbing compound layer 18 which differ therebetween by preferably from 0 to 6 mN/m and more preferably from 0 to 2 mN/m. The difference between the surface tensions of the respective components of the block copolymer is obtained as follows. The contact angles of each component and of the substrate used, with three types of liquids—tetradecane, methylene iodide and water—are measured, and the surface free energies are derived. Next, the surface tension of each component with the substrate is computed, then the difference between these surface tensions can be computed.

### Organic-Inorganic Composite Layer

Each of the organic-inorganic composite layers 20 and 22 of the present invention includes the polymer phase and the metal phase. In addition, the organic-inorganic composite layer 20 or 22 has the microphase-separated morphology formed in such a manner that one of the phases makes up cylindrical or lamellar microdomains oriented substantially perpendicularly to the flexible substrate 14.

First of all, in order to prepare the organic-inorganic composite layer 20 or 22, a block copolymer is used to form on the adsorbing compound layer 18 a microphase-separated morphology in which a cylindrical or lamellar phase which is also referred to as “microdomains” is oriented substantially perpendicularly to the flexible substrate 14. Then, one phase in the microphase-separated morphology is removed and this region is filled with a metal.

In the organic-inorganic composite layers 20 and 22, optical anisotropy, anisotropic electrical conductivity, anisotropic thermal conductivity, anisotropic ionic conductivity and anisotropic magnetic properties are imparted to the structure owing to the structural anisotropy of the organic-inorganic composite layers 20 and 22.

The “polymer phase” refers to one containing a polymer as the main component, and the “metal phase” refers to one containing a metal as the main component. The main component as used herein means that each component (polymer or metal) is included in the corresponding phase in an amount of usually at least 80 wt % and more preferably at least 90 wt % with respect to the total phase weight. The upper limit is 100 wt %.

The metal making up the metal phase in the organic-inorganic composite layer is not particularly limited and examples thereof include copper, silver, gold, aluminum, nickel, tin, lead, palladium, and rhodium. Of these, copper, silver, gold, and aluminum are particularly preferred in terms of electrical conductivity and harmfulness. The metal phase may contain in part an oxide of any of the above-described metals or contain two or more of the metals.

The polymer making up the polymer phase in the organic-inorganic composite layer is not particularly limited and examples thereof include polymer chains used in the block copolymer to be described later. In terms of the handleability and the orderliness achieved for the microphase separation, it is preferable to use a polymer selected from the group consisting of polystyrene, polymethyl methacrylate, polybutadiene, polyisoprene, and polyethylene oxide.

### Microphase-Separated Morphology

The organic-inorganic composite layer 20 or 22 has the microphase-separated morphology in which the cylindrical or lamellar phase which is hereinafter also referred to as “microdomains” is oriented substantially perpendicularly to the substrate. As described above, FIG. 1A shows a perspective, cross-sectional view showing the structure having the cylindrical microphase-separated morphology. The “cylindrical microphase-separated morphology” refers to one in which one of the separated phases (microdomains) is cylindrical, and is obtained by using, for example, a diblock copolymer in which polymers A and B are bound at their ends.

As shown in FIG. 1A, the organic-inorganic composite layer 20 has the microphase-separated morphology including the continuous phase 30 composed of a polymer and the cylindrical microdomains 32 distributed within the continuous phase 30 and composed of a metal, and is situated on the surface of the flexible substrate 14. The cylindrical microdomains 32 are distributed within the continuous phase 30 and oriented substantially perpendicularly to the flexible substrate 14, that is, in the Z-axis direction in FIG. 1A. As shown in FIG. 1B, the cylindrical microdomains 32 preferably have a zigzag arrangement in the horizontal plane of the applied film (the plane XY in FIG. 1B), and most preferably form an ordered array having a hexagonal lattice-like pattern. Here, “hexagonal lattice-like” [symbol] denotes a structure in which the angle between one microdomain and two adjacent microdomains is substantially 60 degrees (where “substantially 60 degrees” [symbol] means from 50 to 70 degrees, and preferably from 55 to 65 degrees). The ordered array of microdomains, although exemplified here by assuming a hexagonal lattice-like pattern, is not limited to this arrangement. For example, there are also cases in which the ordered array of microdomains assumes a square arrangement. Nor are the cylindrical microdomains 32 limited to being arranged in an ordered pattern; cases in which the cylindrical microdomains 32 are arranged in a non-ordered pattern are also encompassed by the present invention.

The size (average diameter) of the cylindrical microdomains 32 may be suitably controlled by, for example, the molecular weight of the block copolymer used, and is preferably from 5 to 200 nm, and more preferably from 10 to 150 nm. If the cylindrical microdomains 32 have a shape that is elliptical, the major axis of the ellipse should fall within the above range. The distance between mutually neighboring microdomains (distance between the center axes) may be suitably controlled by means of, for example, the molecular weight of the block copolymer used, and is preferably from 5 to 500 nm, and more preferably from 10 to 250 nm. The size of the microdomains and the distance between the microdomains can be measured by examination with an atomic force microscope or the like.

The term “microdomain” is commonly used to denote the domains in a multiblock copolymer, and is not intended here to specify the size of the domains.

The cylindrical microdomains 32 are oriented perpendicularly to the flexible substrate 14, and are preferably substantially perpendicular. The expression “substantially perpendicular” here denotes that the center axes of the cylindrical microdomains 32 are inclined to the normal of the flexible substrate 14 at an angle of not more than ±45°, and preferably not more than ±30°. The angle of inclination can be measured by the TEM analysis of ultrathin sections, small-angle x-ray diffraction analysis or some other suitable technique.

The cylindrical microdomains 32 made of a metal in FIG. 1A extend through the organic-inorganic composite layer 20, but are not limited to the embodiment shown in FIG. 1A. More specifically, the cylindrical microdomains 32 made of a metal in FIG. 1A has a height h₁ of preferably at least 10 nm and more preferably at least 30 nm. The upper limit of the height corresponds to the thickness of the organic-inorganic composite layer 20 plus about 5 to about 200 nm by which the upper portion of the cylindrical microdomain 32 protrudes from the organic-inorganic composite layer 20. A height exceeding the above range may cause electrical connection between the adjacent cylindrical microdomains made of a metal to be established and is not preferable.

As described above, FIG. 2A shows a perspective, cross-sectional view of the structure having the lamellar microphase-separated morphology. The “lamellar microphase-separated morphology” refers to one in which one of the phases is lamellar (in plate form), and is obtained by using, for example, a diblock copolymer in which the polymers A and B are bound at their ends. As shown in FIG. 2A, the lamellar phase portions (portions in plate form) are alternately disposed in the organic-inorganic composite layer 22. The lamellar phases 34 and 36 are a polymer phase and a metal phase, respectively. The lamellar phases are oriented perpendicularly to the flexible substrate 14, that is, in the Z-axis direction in FIG. 2A.

The (average) width of the lamellar phases 34 and 36 may be suitably controlled by, for example, the molecular weight of the block copolymer used, and is preferably from 5 to 200 nm, and more preferably from 10 to 150 nm. The width of the lamellar phases can be measured by, for example, examination with an atomic force microscope.

The lamellar phases 34 and 36 are oriented perpendicularly to the flexible substrate 14, and are preferably substantially perpendicular. The expression “substantially perpendicular” here means that the interfaces between the lamellar phases in the Z-axis direction in FIG. 2A are inclined to the normal of the flexible substrate 14 at an angle of not more than ±45°, and preferably not more than ±30°. The angle of inclination can be measured by the TEM analysis of ultrathin sections, small-angle x-ray diffraction analysis, or some other suitable technique.

The present invention is not limited to cases in which the organic-inorganic composite layers 20 and 22 have an ordered pattern as a whole; cases in which the layers have, in part, a non-ordered pattern are also encompassed by the present invention.

The average thickness of each of the organic-inorganic composite layers 20 and 22 may be suitably controlled by varying, for example, the concentration in solution of the block copolymer during the formation of the composite layer, although the thickness is preferably from 10 to 5000 nm, and more preferably from 50 to 2500 nm. Within this range, the orderliness of the resulting microphase-separated morphology is further enhanced. The layer thickness is obtained by taking measurements at three or more random points with a suitable known apparatus such as a profiler (KLA-Tencor Corp.), and calculating the arithmetical mean of the measurements.

The structures 10 and 12 of the present invention are layered structural bodies (multilayer bodies) as described above, and the specific shapes thereof are not subject to any particular limitation; an optimal shape may be suitably selected according to the intended purpose. A film-like shape having a thickness of from 0.05 to 500 μm is preferred.

### Applications

In the layered structural body (multilayer body) of the present invention, because the substrate is a flexible substrate, the structural body itself has ample flexibility, providing considerable potential for use in a broad range of fields and applications. Examples of possible applications include photomasks, anisotropic electrically conductive films, anisotropic ion-conductive films, photonic crystals, phase shift films, polarizing films, screens, color filters, components for electronic displays, photoelectric conversion elements, nanoimprint molds, magnetic recording media, acoustic vibration materials, sound-absorbing materials and vibration-damping materials. Use in photomasks, anisotropic electrically conductive films, anisotropic ion-conductive films, photonic crystals, phase shift films and polarizing films is especially promising.

In particular, the structure of the present invention has the metallic material arranged in a specific direction, and therefore use in, for example, anisotropic electrically conductive films, anisotropic thermally conductive films, anisotropic ion-conductive films, low-dielectric-constant films, membranes for protein separation, and biosensors can be promising.

### Structure-Manufacturing Method

Next, the method of manufacturing the structure (multilayer body) of the present invention is not particularly limited but a manufacturing method mainly including the following steps is preferably used.

(Step 1) forming a conductive layer on a flexible substrate;
(Step 2) forming an adsorbing compound layer on the conductive layer using an adsorbing compound;
(Step 3) forming on the adsorbing compound layer a block copolymer layer made of a block copolymer and having a microphase-separated morphology in which one of phases is a lamellar or cylindrical phase oriented perpendicularly to the flexible substrate;
(Step 4) removing one of the phases of the microphase-separated morphology in the block copolymer layer formed in Step 3;
(Step 5) filling the region of the phase removed in Step 4 with a metal.

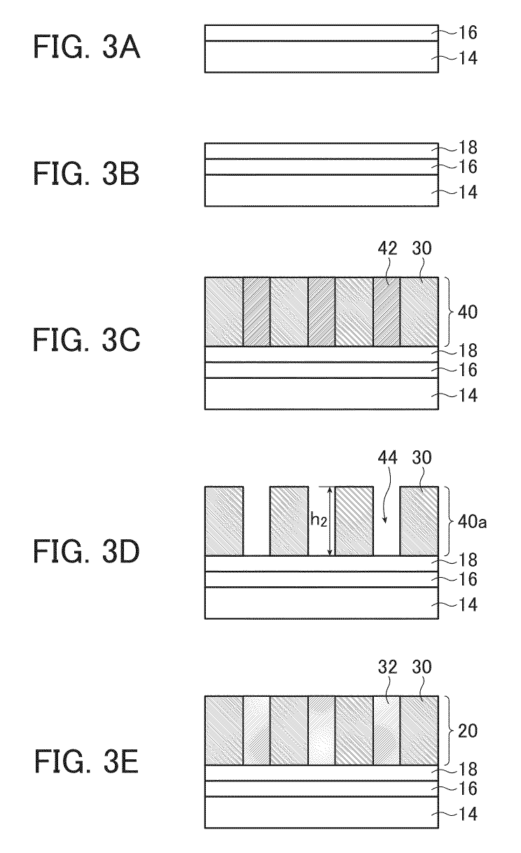

Each of these steps and the materials used therein are described in detail below. The respective steps are described below with reference to a typical example shown in the cross-sectional views of FIGS. 3A to 3E. In FIGS. 3A to 3E, the microphase-separated morphology having the cylindrical microdomains is formed.

### Step 1

Step 1 is the step of forming the conductive layer 16 on the flexible substrate 14 (conductive layer-forming step) (see FIG. 3A) .

The method of forming the conductive layer 16 on the above-described flexible substrate 14 is not particularly limited and an optimal method is suitably selected based on the type of metal to be deposited. Examples of the method that may be used include physical vapor deposition processes such as vacuum evaporation and sputtering, chemical vapor deposition processes, and plating. Of these, a vacuum evaporation or sputtering process is preferable on account of the ease of controlling such properties as the thickness and density of the layer obtained.

### Step 2

Step 2 is the step of forming the adsorbing compound layer 18 on the conductive layer 16 obtained in Step 1 (adsorbing compound layer-forming step) (see FIG. 3B).

The method of forming the adsorbing compound layer 18 on the conductive layer 16 is not particularly limited and the method described in, for example, Chemical Review, vol. 105, pp. 1103-1169 (2005) may be used. Specific examples include methods in which the adsorbing compound is coated, either directly as is or after dissolution in a solvent, onto the conductive layer; and methods in which the substrate on which the conductive layer has been deposited is immersed in a solution containing the adsorbing compound. The reaction time and temperature are selected as appropriate for the method and the adsorbing compound which are used. Following treatment with the adsorbing compound, if necessary, rinsing with a solvent may be carried out.

The solvent used for preparing the solution containing the adsorbing compound is selected as appropriate as long as the adsorbing compound is dissolved therein. Illustrative examples include toluene, chloroform, dichloromethane, ethanol, methanol, dimethylformamide, dimethylacetamide, dimethylsulfoxide, acetone, methyl ethyl ketone, hexane, octane, tetrahydrofuran, dioxane, and water.

The concentration of the adsorbing compound in the solution is preferably from 0.10 to 5.0 wt %, and more preferably from 0.50 to 2.0 wt % with respect to the total amount of the solution. Within the above range, a more uniform adsorbing compound layer is readily obtained.

### Step 3

Step 3 is the step of forming the block copolymer layer 40 on the adsorbing compound layer 18 obtained in Step 2 (see FIG. 3C). FIG. 3C shows the block copolymer layer 40 formed of the block copolymer including the polymers A and B. The block copolymer layer 40 includes the continuous phase 30 composed of the polymer B and the cylindrical microdomains 42 oriented perpendicularly to the substrate and composed of the polymer A.

As will be described later, the microphase-separated morphology having the cylindrical microdomains or that having the lamellar phases can be suitably produced by changing the type of block copolymer used.

The method of forming the block copolymer layer 40 on the adsorbing compound layer 18 is not subject to any particular limitation. However, from the standpoint of the ease of controlling layer thickness, a method which involves coating the block copolymer-containing solution is preferred.

The coating method is not subject to any particular limitation. Common coating methods which may be used include spin coating, solvent casting, dip coating, roll coating, curtain coating, slide coating, extrusion coating, bar coating and gravure coating. From the standpoint of productivity and other considerations, spin coating is preferred. The spin coating conditions are suitably selected according to the block copolymer used. After coating, a drying step may be carried out if necessary. The drying conditions for solvent removal are suitably selected according to the substrate employed and the block copolymer used, although it is preferable to carry out such treatment at a temperature of from 20 to 250° C. for a period of from 0.5 to 336 hours. The drying temperature is more preferably from 20 to 240° C., and even more preferably from 25 to 230° C. Such drying treatment may be carried out in several divided stages. This drying treatment is most preferably carried out in a nitrogen atmosphere, in low-concentration oxygen or at an atmospheric pressure of 10 torr or less.

Next, the block copolymer which is the material used in Step 3 is described. Block Copolymer

The term “block copolymer” generally refers to a copolymer in which a plurality of types of homopolymer chain are bonded to each other as blocks (components). For example, there are polymers in which a polymer A chain composed of monomer A repeating units and a polymer B chain composed of monomer B repeating units are bonded together at their respective ends.

The block copolymer used in the present invention is composed of two or more types of polymers that are mutually incompatible, and may be in the form of any one of the following: a diblock copolymer, a triblock copolymer or a multiblock copolymer. Specifically, referring to a portion composed of polymer A as an “A block” and a portion composed of polymer B as a “B block,” exemplary block copolymers include A-B type block copolymers having an -A-B- structure and composed of one A block bonded with one B block, A-B-A type block copolymers having an -A-B-A- structure and composed of A blocks bonded to both ends of a B block, and B-A-B type block copolymers having a -B-A-B- structure and composed of B blocks bonded to both ends of an A block. In addition, use may also be made of block copolymers which have a -(A-B)ₙ- structure and are composed of a plurality of A blocks and B blocks. Of these, from the standpoint of availability and ease of synthesis, A-B type block copolymers (diblock copolymers) are preferred. The chemical bonds connecting the polymers to each other are preferably covalent bonds.

Illustrative examples of the polymers which make up the block copolymer used in the present invention include vinyl polymers such as polystyrene, polymethylstyrene, polydimethylstyrene, polytrimethylstyrene, polyethylstyrene, polyisopropylstyrene, polychloromethylstyrene, polymethoxystyrene, polyacetoxystyrene, polychlorostyrene, polydichlorostyrene, polybromostyrene, polytrifluoromethylstyrene, polymethyl methacrylate, polyethyl methacrylate, polybutyl methacrylate, polyisobutyl methacrylate, polyhexyl methacrylate, poly(2-ethylhexyl methacrylate), polyisodecyl methacrylate, polylauryl methacrylate, polyphenyl methacrylate, polymethoxyethyl methacrylate, polymethyl acrylate, polyethyl acrylate, polybutyl acrylate, polyhexyl acrylate, poly(2-ethylhexyl acrylate), polyphenyl acrylate, polymethoxyethyl acrylate, polyglycidyl acrylate, polyvinyl acetate, polyvinyl propionate, polyvinyl butyrate, polyvinyl isobutyrate, polyvinyl caproate, polyvinyl chloroacetate, polyvinyl methoxyacetate, polyvinyl phenyl acetate, polyethylene, polypropylene, polyisobutylene, polyvinyl chloride, polyvinylidene chloride, polytetrafluoroethylene and polyvinylidene fluoride; diene polymers such as polybutadiene and polyisoprene; ether polymers such as polymethylene oxide, polyethylene oxide, polythioether, polydimethylsiloxane and polyethersulfone; ester-based condensation polymers such as poly(E-caprolactone) and polylactic acid; and amide-based condensation polymers such as nylon 6, nylon 66, poly(m-phenylene isophthalamide), poly(p-phenylene terephthalamide) and polypyromellitimide. The combination of polymer chains making up the block copolymer is not subject to any particular limitation, provided the polymer chains used are mutually incompatible. For example, combinations of different vinyl copolymers, a vinyl polymer with a diene polymer, a vinyl polymer with an ether polymer, a vinyl polymer with an ester-based condensation polymer, or different diene polymers are preferred. The use of one or more vinyl polymers is more preferred. The use of a combination of different vinyl polymers is most preferred.

More specific examples include polystyrene/polymethyl methacrylate, polystyrene/polyethylene oxide, polyisoprene/poly(2-vinylpyridine), polymethyl acrylate/polystyrene, polybutadiene/polystyrene, polyisoprene/polystyrene, polystyrene/poly(2-vinylpyridine), polystyrene/poly(4-vinylpyridine), polystyrene/polydimethylsiloxane, polybutadiene/polyethylene oxide and polystyrene/polyacrylic acid.

Of these, from the standpoint of availability and versatility, block copolymers such as polystyrene/polymethyl methacrylate, polystyrene/polyethylene oxide, polyisoprene/polystyrene, polystyrene/poly(2-vinylpyridine), polystyrene/poly(4-vinylpyridine) and polybutadiene/polyethylene oxide are preferred.

The block copolymer in the present invention is preferably one in which the mutually incompatible polymer block chains making up the block copolymer have a large difference in polarity. The polarity difference can be numerically expressed as, for example, the solubility parameter difference (SP difference). The solubility parameter can be estimated from the molecular structure. Numerous methods for calculating the theoretical solubility parameter have been proposed, including those of Small, Hoy and Fedors. Of these, Fedors theoretical solubility parameter does not require the polymer density parameter, and thus is an effective method of calculation also for polymers having a novel structure (Nippon Setchaku Kyokaishi 22, No. 10, 564-567 (1986)). In Fedors method of calculation, the theoretical solubility parameter (units: (cal/cm³)^{1/2}) can be determined by formula 3 below using the bond energy and energy of molecular motion Δei possessed by the atoms or atomic groups such as polar radicals making up the polymer, the bond energy and energy of molecular motion ΣΔei of repeating units making up the polymer, the occupied volume Δvi of atoms or atomic groups such as polar radicals making up the polymer, and the occupied volume ΣΔvi of repeating units making up the polymer.

SP=(ΣΔei/ΣΔvi)^{1/2} Formula 3

For example, the theoretical solubility parameter for polystyrene is estimated to be 14.09 (cal/cm³)^{1/2} and the theoretical solubility parameter for polymethyl methacrylate is estimated to be 10.55 (cal/cm³)^{1/2}. Therefore, the polarity difference (SP difference) in a block copolymer composed of a polystyrene block chain and a polymethyl methacrylate block chain is 3.54 (cal/cm³)^{1/2}.

The weight-average molecular weight (Mw) of the block copolymer according to the present invention is suitably selected according to the intended use, and is preferably at least 1×10⁴, more preferably from 1×10⁴ to 1×10⁷, and even more preferably from 5×10⁴ to 1×10⁶. This weight-average molecular weight (Mw) is the polystyrene-equivalent weight-average molecular weight obtained following measurement by gel permeation chromatography (GPC).

The block copolymer of the present invention preferably has a narrow molecular weight distribution. Specifically, the molecular weight distribution (Mw/Mn) expressed in terms of the weight-average molecular weight (Mw) and the number-average molecular weight (Mn) is preferably from 1.00 to 1.50, and more preferably from 1.00 to 1.15. By having the Mw/Mn value fall within the above range, a microphase-separated morphology of more uniform size can be formed.

The copolymerization ratio of the block copolymer in the present invention is suitably selected so as to enable a cylindrical or lamellar microphase-separated morphology to be obtained in the block copolymer layer 40.

For example, in the case of a cylindrical microphase-separated morphology composed of a diblock copolymer (A-B type) or a triblock copolymer (A-B-A type) as shown in FIG. 1A, the volumetric ratio between the polymer A and the polymer B which make up the copolymer (polymer A/polymer B) is preferably from 0.9/0.1 to 0.65/0.35 or from 0.35/0.65 to 0.1/0.9, and more preferably from 0.8/0.2 to 0.7/0.3 or from 0.3/0.7 to 0.2/0.8. Within the above range, a cylindrical microphase-separated morphology having a more highly ordered array can be obtained.

In the case of a similarly composed lamellar microphase-separated morphology as shown in FIG. 2A, the volumetric ratio between the polymer A and the polymer B which make up the copolymer (polymer A/polymer B) is preferably from 0.65/0.35 to 0.35/0.65, and more preferably from 0.6/0.4 to 0.4/0.6. Within the above range, a lamellar microphase-separated morphology having a more highly ordered array can be obtained.

The block copolymer of the present invention may be synthesized by a known method. Commercially available products may also be used.

The solvent used for preparing the solution containing the block copolymer should be one which dissolves the block copolymer, and is suitably selected according to the types of both polymers. Illustrative examples include toluene, chloroform, dichloromethane, dimethylformamide, dimethylacetamide, dimethylsulfoxide, tetrahydrofuran, 1,4-dioxane, acetone, diethylketone, methyl ethyl ketone, methyl isobutyl ketone, isopropanol, ethanol, methanol, hexane, octane, tetradecane, cyclohexane, cyclohexanone, acetic acid, ethyl acetate, methyl acetate, pyridine, N-methylpyrrolidone and water. Of these, toluene, chloroform, dichloromethane, dimethylformamide and methyl ethyl ketone are preferred.

The concentration of the block copolymer in the solution is preferably from 0.10 to 20.0 wt %, and more preferably from 0.25 to 15.0 wt % with respect to the total amount of the solution. Within this range, the solution is easy to handle during coating and a uniform film can readily be obtained.

Following the completion of Step 3, if necessary, the structure (multilayer body) obtained in Step 3 may be subjected to heat treatment (heating step). The heating temperature and time are suitably set in accordance with the block copolymer used and the layer thickness, although heating is generally carried out at or above the glass transition temperature of the block copolymer. The heating temperature may typically be set in a range of from 60 to 300° C., although a temperature of from 80 to 270° C. is preferred based on the glass transition temperature of the monomer units making up the block copolymer. A heating time of at least one minute is suitable, although a heating time of from 10 to 1,440 minutes is preferred. To prevent oxidative degradation of the block copolymer film by heating, heating is preferably carried out in an inert atmosphere or a vacuum.

Following the completion of Step 3, if necessary, the structure (multilayer body) obtained in Step 3 may be treated by exposure to an organic solvent vapor atmosphere (solvent treatment step). The organic solvent employed for this purpose is suitably selected according to the block copolymer used. Preferred examples include benzene, toluene, xylene, acetone, methyl ethyl ketone, chloroform, methylene chloride, tetrahydrofuran, dioxane, hexane, octane, methanol, ethanol, acetic acid, ethyl acetate, diethyl ether, carbon disulfide, dimethylformamide and dimethylacetamide. Of these, toluene, xylene, acetone, methyl ethyl ketone, chloroform, tetrahydrofuran and dioxane are preferred. Toluene, methyl ethyl ketone, chloroform and dioxane are more preferred.

### Step 4

Step 4 is the step of removing one of the phases of the microphase-separated morphology in the block copolymer layer (removal step). More specifically, a porous body having nanosize pores can be obtained by removing the polymer chains within one of the phases in the lamellar or cylindrical microphase-separated morphology that forms within the block copolymer layer. For example, as shown in FIG. 3D, this step removes the cylindrical microdomains 42 shown in FIG. 3C to form pores 44 in the block copolymer layer 40a.

Removal may be carried out using, without particular limitation, any suitable method known in the art. Illustrative examples of methods for decomposing and removing one of the phases (decomposition step) include ion beam etching, ozonolysis treatment, UV irradiation and deep-UV irradiation. Use is made of a method and conditions which are suitable and optimal for the polymer material to be decomposed. Of the above, UV irradiation and deep-UV irradiation are preferred. The source of ultraviolet light may be, for example, a high-pressure mercury vapor lamp or an electrodeless lamp. The illuminance of UV light, while not subject to any particular limitation, is preferably from 10 to 300 mW. The total dose of UV light is preferably from 1 to 50 J/cm². It is also possible to use other methods of decomposition and removal, such as thermal decomposition of the polymer material by heating the polymer material to be decomposed to or above its thermal decomposition temperature.

Following the above removal by decomposition, a washing step with a suitable solvent (e.g., acetic acid, methanol, water) may be carried out. The size of the pores obtained by the above method corresponds to the size of the above-described cylindrical microdomains or the lamellar phases.

In FIG. 3D, the cylindrical microdomains 42 are all removed but may only be partially removed. More specifically, the depth (h2) of the pores 44 is suitably adjusted by controlling the etching conditions. From the viewpoint of use in various applications, the pores 44 preferably have a depth (h₂) of at least 50 nm and more preferably at least 80 nm. The maximum value corresponds to the thickness of the block copolymer layer 40. The depth (h₂) refers to the distance from the surface of the block copolymer layer 40 away from the substrate 14 to the pore bottom.

### Step 5

Step 5 is the step of filling the region (pores) of the phase removed from the block copolymer layer obtained in Step 4 with a metal (filling step). As shown in FIG. 3E, the structure having the organic-inorganic composite layer 20 containing the cylindrical microdomains 32 made of a desired metal can be obtained by this step which involves filling the pores 44 shown in FIG. 3D with the metal.

The method of metal filling is not particularly limited and examples thereof include vapor deposition and plating. Of these, plating is preferred because the amount of metal to be filled is easily controlled. In cases where plating is used, the conductive layer in the structure is presumed to play a role of plating nucleus, thus enabling a metal to be efficiently filled into the pores 44.

Electroless plating or electrolytic plating may be used for plating. Of these, electrolytic plating is preferred because the amount of metal to be filled can be more easily controlled.

### Electroless Plating

“Electroless plating” refers to an operation with which a metal is precipitated by a chemical reaction using a solution in which metal ions to be precipitated by plating are dissolved.

Electroless plating is carried out by, for example, immersing the structure obtained in Step 4 in an electroless plating bath. Any known electroless plating bath may be used for electroless plating. In addition to a solvent, the composition of a commonly used electroless plating bath mainly includes 1. metallic ions for plating, 2. a reducing agent, and 3. an additive for improving the stability of the metallic ions (stabilizer). In addition to these components, this plating bath may include known additives such as a stabilizer for the plating bath.

The solvent that may be used for the electroless plating bath is not particularly limited as long as the metal compound for supplying the metallic ions for plating can be dissolved therein. Examples of the solvent that may be preferably used include water, ketones such as acetone, and alcohols such as methanol, ethanol, and isopropanol.

Of these, a mixed solution of water and an organic solvent such as methanol is preferred in terms of efficient filling of a metal. The volumetric mixing ratio of water to the organic solvent is preferably 95:5 to 50:50.

The kind of the metal to be used for the electroless plating bath is selected as appropriate for the metal to be filled. Examples of the metal include copper, silver, gold, aluminum, nickel, tin, lead, palladium, and rhodium. Of these, copper, silver, gold, and aluminum are particularly preferred in terms of electrical conductivity and harmfulness.

Examples of the source of these metals include hydrochlorides, sulfates, nitrates, pyrophosphates and sulfamates of the foregoing metals. More specific examples include chlorauric acid, copper sulfate, silver nitrate, copper pyrophosphate, and nickel sulfamate.

Any known reducing agents may be used for the electroless plating bath without particular limitation. Exemplary reducing agents include monoalkylamine borane, dialkylamine borane, hypophosphorous acid, hypophosphite, and formalin. Other reducing methods that may be used include reduction by UV irradiation or by application of heat.

The time of immersion in the electroless plating bath is suitably adjusted based on, for example, the amount of metal to be filled. In terms of productivity, the time of immersion is preferably from about 10 seconds to about 60 minutes.

The temperature of the electroless plating bath that may be used is not particularly limited and is preferably from 20° C. to 60° C. in terms of productivity. The reducing agents and additives best suited for the metal used may be added to the electroless plating bath. For example, the electroless copper plating bath contains a copper salt (CuSO₄), a reducing agent (HCOH) and additives such as a copper ion stabilizer (EDTA), a chelating agent (Rochelle salt) and a trialkanolamine. The plating bath that may be used in the electroless CoNiP plating contains metal salts (cobalt sulfate and nickel sulfate), a reducing agent (sodium hypophosphite), and a complexing agent such as sodium malonate, sodium malate or sodium succinate. The electroless palladium plating bath contains a metallic ion ((Pd(NH₃)₄)Cl₂), a reducing agent (NH₃, H₂NNH₂) and a stabilizer (EDTA). These plating baths may contain components other than the above.

Commercial products may be used for the plating solution as exemplified by THRU-CUP PGT available from C. Uyemura & Co., Ltd., and ATS Addcopper IW available from Okuno Chemical Industries Co., Ltd.

### Electrolytic Plating

Electrolytic plating can be carried out by using the conductive layer of the structure obtained in Step 4 as the electrode. More specifically, the structure obtained in Step 4 is immersed in the plating bath, the conductive layer in the structure is made to serve as the electrode and a current is applied to enable electrolytic plating.

Any conventionally known method may be used for electrolytic plating.

The kind of the metal to be used for the electrolytic plating bath is selected as appropriate for the metal to be filled. Examples of the metal include copper, silver, gold, aluminum, nickel, tin, lead, palladium, and rhodium.

Those described above for electroless plating may be used for the source of these metals.

The solvent that may be used for the electrolytic plating bath is not particularly limited as long as the metal compound which supplies the metallic ions for plating can be dissolved therein, and preferred examples include the foregoing solvents that may be used for the electroless plating bath.

Optimal conditions of electrolytic plating are suitably selected based on, for example, the plating bath used. For example, the current density during electrolytic plating is preferably from 0.1 to 100 mA/cm² in terms of productivity.

The electrolytic plating time is preferably from 10 to 1,000 seconds in terms of productivity.

The temperature of the electrolytic plating bath that may be used is not particularly limited and is preferably from 20° C. to 80° C. in terms of productivity.

The conductive layer may be formed by vapor deposition in place of electrolytic plating with reference to, for example,

Adv. Mater. 2000, 12, No. 14, 1031-1033.

Steps 3 and 4 may be carried out with reference to the method described in J. AM. CHEM. SOC. 2003, 125, 12211-12216.

The following steps may be carried out in place of Steps 3 and 4 to obtain a porous body having cylindrical pores;

(1) forming a film by coating an adsorbing compound layer surface having a contact angle with water of between 40° and 110° with a solution containing a block copolymer composed of a water-insoluble polymer A and a water-soluble polymer B which are mutually incompatible and a water-soluble homopolymer B, the block copolymer and the water-soluble homopolymer B satisfying formulas (4) and (5); and
(2) removing the water-soluble homopolymer B in the film obtained in the film-forming step with water to prepare a porous body.

5<M(b1)/M(b2)<250 Formula (4)

0.60≦a1/(a1+b1+b2) ≦0.90 Formula (5)

In formula (4), M(b1) represents the weight-average molecular weight of the water-soluble polymer B of the block copolymer, and M(b2) represents the weight-average molecular weight of the water-soluble homopolymer B.

In formula (5), al represents the volume of the water-insoluble polymer A of the block copolymer in the film, b1 represents the volume of the water-soluble polymer B of the block copolymer in the film and b2 represents the volume of the water-soluble homopolymer B [symbol] in the film.

The materials used in the respective steps and the respective steps are described below.

The film-forming step uses the block copolymer including the water-insoluble polymer A and the water-soluble polymer B which are incompatible with each other, and the water-soluble homopolymer B. The respective materials are described below.

The water-insoluble polymer A [symbol] is defined as a polymer having a polymer solubility in 100 g of distilled water at 25° C. of 1 g or less. Polymers having a polymer solubility in 100 g of distilled water at 25° C. of 1 g or less may be selected for use from among those mentioned in, for example, paragraphs [0061] to

of JP 11-15091 A or in Polymer Handbook Fourth Edition, Volumes 1 & 2 by J. Brandrup, E. H. Immergut, E. A. Grulke, et al.; published by Interscience; chapter VII, pp. 499-532.

Of these, polyalkylenes, polyvinyl esters, polyvinyl halides, polystyrenes, poly(meth)acrylates, polysiloxanes, polyesters, polybutadienes and polyisoprenes are preferred in terms of the ease of synthesizing a polymer of uniform molecular weight. From the standpoint of having a glass transition temperature higher than room temperature, polystyrenes (e.g., polystyrene, polymethylstyrene, polydimethylstyrene, polytrimethylstyrene, polyethylstyrene, polyisopropylstyrene, polychloromethylstyrene, polymethoxystyrene, polyacetoxystyrene, polychlorostyrene, polydichlorostyrene, polybromostyrene, polytrifluoromethylstyrene), poly(meth)acrylates (e.g., polymethyl (meth)acrylate, polyethyl (meth)acrylate, polybutyl (meth) acrylate, polyhexyl (meth) acrylate, poly-2-ethylhexyl (meth)acrylate, polyphenyl (meth)acrylate, polymethoxyethyl (meth) acrylate, polyglycidyl (meth) acrylate), polybutadienes (e.g., 1,2-polybutadiene, 1,4-polybutadiene) and polyisoprenes (e.g., polyisoprene) are more preferred. Polystyrene, polymethyl methacrylate, 1,4-polybutadiene and polyisoprene are especially preferred.

The weight-average molecular weight (Mw) of the water-insoluble polymer A in the block copolymer is suitably selected based on the size of the pores in the porous body to be obtained and the relationship with the molecular weight of the subsequently described water-soluble homopolymer B [symbol] and is preferably between 1.0×10⁴ and 1.0×10⁶, and more preferably between 5.0×10⁴ and 5.0×10⁵. Within the above range, the block copolymer readily dissolves in the solvent at the time of porous body production, in addition to which the pore array obtained is more highly ordered.

The water-soluble polymer B [symbol] is defined as a polymer having a polymer solubility in 100 g of distilled water at 25° C. of more than 1 g. Polymers having a polymer solubility in 100 g of distilled water at 25° C. of more than 1 g may be selected for use from among those mentioned in, for example, paragraphs [0038] to

of JP 2005-10752 A or Polymer Handbook Fourth Edition, Volumes 1 & 2 by J. Brandrup, E. H. Immergut, E. A. Grulke, et al.; published by Interscience; chapter VII; pp. 499-532.

Of these, from the standpoint of synthesizing a polymer having a uniform molecular weight, carboxyl group-containing polymers and their salts, sulfonic acid group-containing polymers and their salts, phosphoric acid group-containing polymers and their salts, phosphorylcholine group-containing polymers, amino group-containing polymers (e.g., polyallylamine, polyethyleneimine), amide group-containing polymers and ether group-containing polymers are preferred.

Ether group-containing polymers (e.g., polymethyl vinyl ether, polyalkylene glycols such as polyethylene glycol, polyethylene glycol monoethyl ether (meth)acrylate) and phosphorylcholine group-containing polymers (e.g., poly-2-methacryloxyethylphosphorylcholine, poly-4-(meth)acryloxybutylphosphorylcholine, poly-6-(meth)acryloxyhexylphosphorylcholine) are more preferred.

The weight-average molecular weight (Mw) of the water-soluble polymer B in the block copolymer is suitably selected based on the size of the pores in the porous body to be obtained and the relationship with the molecular weight of the subsequently described water-soluble homopolymer B [symbol] and is preferably between 1.0×10³ and 1.0×10⁵, and more preferably between 5.0×10³ and 5.0×10⁴. Within the above range, the block copolymer readily dissolves in the solvent at the time of porous body production, in addition to which the pore array obtained is more highly ordered.

The block copolymer used in the above step is composed of water-insoluble polymer A and water-soluble polymer B which are mutually incompatible, and is synthesized by combining the respective polymers described above. Preferred forms of the block copolymer include block copolymers in which the water-insoluble polymer A is polystyrene and the water-soluble polymer B is polyethylene glycol, block copolymers in which the water-insoluble polymer A is polybutadiene and the water-soluble polymer B is polyethylene glycol, and block copolymers in which the water-insoluble polymer A is polymethyl methacrylate and the water-soluble polymer B is poly(2-methacryloxyethylphosphorylcholine).

The weight-average molecular weight (Mw) of the block copolymer used in the above step is suitably selected based on the size of the pores in the porous body to be obtained and the relationship with the molecular weight of the subsequently described water-soluble homopolymer B [symbol] and is preferably between 1.1×10⁴ and 1.1×10⁶, and more preferably between 5.5×10⁴ and 5.5×10⁵. Within the above range, the block copolymer readily dissolves in the solvent at the time of porous body production, in addition to which the pore array obtained is more highly ordered.

The block copolymer used in this step preferably has a narrow molecular weight distribution. Specifically, the molecular weight distribution (Mw/Mn) expressed in terms of the weight-average molecular weight (Mw) and the number-average molecular weight (Mn) is preferably from 1.00 to 1.30, and more preferably from 1.00 to 1.15. By having the Mw/Mn value fall within the above range, a microphase-separated morphology of more uniform size can be formed.

The copolymerization ratio of the block copolymer is suitably selected so as to satisfy subsequently described formulas (4) and (5) and so as to enable a cylindrical microphase-separated morphology to be obtained. The volumetric copolymerization ratio expressed as water-insoluble polymer A/water-soluble polymer B is preferably between 0.9/0.1 and 0.65/0.35, and more preferably between 0.8/0.2 and 0.7/0.3. Within the above range, a cylindrical microphase-separated morphology having a more highly ordered array can be obtained.

### Water-Soluble Homopolymer B

The water-soluble homopolymer B is a polymer having the same constituent monomers as the water-soluble polymer B in the above-described block copolymer. The definition of the water-soluble homopolymer B is identical to that of the water-soluble polymer B in the above-described block copolymer.

The weight-average molecular weight (Mw) of the water-soluble homopolymer B of the present invention is suitably selected based on the size of the pores in the porous body to be obtained and the relationship with the molecular weight of the block copolymer, and is preferably from 50 to 1.0×10⁴, and more preferably from 50 to 5.0×10³.

The water-soluble homopolymer B preferably has a narrow molecular weight distribution. Specifically, the molecular weight distribution (Mw/Mn) expressed in terms of the weight-average molecular weight (Mw) and the number-average molecular weight (Mn) is preferably from 1.0 to 3.0, and more preferably from 1.0 to 1.5. By having the Mw/Mn value fall within the above range, a microphase-separated morphology of more uniform size can be formed.

### Formula (4)

Next, the relationship between the molecular weight of the block copolymer composed of water-insoluble polymer A and water-soluble polymer B and the molecular weight of the water-soluble homopolymer B is described. The block copolymer and the water-soluble homopolymer B satisfy formula (4) below:

5<M(b1)/M(b2)<250 Formula (4)

wherein M(b1) represents the weight-average molecular weight of the water-soluble polymer B of the block copolymer, and M(b2) represents the weight-average molecular weight of the water-solublehomopolymer B.

If the above M(b1)/M(b2) value is 5 or less, the block copolymer and the water-soluble homopolymer B phase-separate at the micrometer level, and a microphase-separated morphology having the desired degree of order may not be attainable. If this value is 250 or more, the water-soluble homopolymer B has too small a molecular weight, making it difficult to control the pore size of the resulting porous body.

To further improve the degree of order of the microphase-separated morphology obtained, it is more preferable for the ratio M(b1)/M(b2) to satisfy the following condition: 10<M(b1)/M(b2)<200.

### Formula (5)

Next, the mixing ratio between the block copolymer, which is composed of water-insoluble polymer A and water-soluble polymer B, and the water-soluble homopolymer B is described. The block copolymer and the water-soluble homopolymer B satisfy formula (5) below:

0.60≦a1/(a1+b1+b2)≦0.90 Formula (5)

wherein a1 represents the volume of the water-insoluble polymer A of the block copolymer in the film, bl represents the volume of the water-soluble polymer B of the block copolymer in the film and b2 represents the volume of the water-soluble homopolymer B [symbol] in the film.

If the above a1/(a1+b1+b2) value is smaller than 0.60, the microphase-separated morphology becomes a lamellar morphology, making it impossible to obtain the desired cylindrical morphology. On the other hand, if the a1/(a1+b1+b2) value is larger than 0.90, the water-soluble polymer B will assume a spherical morphology within the water-insoluble polymer A component, making it impossible to obtain the desired cylindrical morphology. The volumes are derived by using the densities and weights of the respective polymers.

When the a1/(a1+b1+b2) value is between 0.60 and 0.90, microphase separation having a cylindrical morphology is formed by the block copolymer and the water-soluble homopolymer B. More specifically, the cylindrical domains within the microphase separated morphology are composed of the water-soluble polymer B in the block copolymer and the water-soluble homopolymer B, and are oriented perpendicularly to the film surface. On passing through the subsequently described water rinsing treatment, the water-soluble homopolymer B is selectively removed, thereby giving the desired porous body having a plurality of pores of cylindrical shape that are oriented perpendicularly to the film surface.

Next, the adsorbing compound layer on which a mixed thin-film of the block copolymer and the water-soluble homopolymer B is to be deposited is described. It is necessary for the adsorbing compound layer for which this step is carried out to have a contact angle with water on the surface of the adsorbing compound layer of 40° to 110° and preferably 50° to 105°. “Contact angle” refers herein to the static contact angle, which is measured by the sessile drop method at 23° C. using a contact angle goniometer. As used herein, “static contact angle” refers to the contact angle under conditions where changes in state associated with time due to flow or the like do not arise.

At a contact angle within the above-defined range, the microphase-separated morphology can be manufactured in which the cylindrical microdomains are oriented perpendicularly to the flexible substrate.

### Film-Forming Step

The film-forming step is the step of forming a film by coating the adsorbing compound layer with a solution containing the above-described block copolymer and water-soluble homopolymer B.

This step enables the block copolymer layer having the microphase-separated morphology including the cylindrical microdomains oriented perpendicularly to the flexible substrate to be formed on the adsorbing compound layer. The continuous phase is primarily composed of the water-insoluble polymer A and the cylindrical microdomains are primarily composed of the water-soluble polymer B in the block copolymer and the water-soluble homopolymer B.

The solvent used for preparing the solution containing the block copolymer and water-soluble homopolymer B should be one which dissolves the block copolymer, and is suitably selected according to the types of both polymers.

More specifically, aromatic hydrocarbons (e.g., toluene, xylene, cumene), halogenated compounds (chloroform, dichloromethane, trichloroethane, carbon tetrachloride), amides (e.g., formamide, N,N-dimethylformamide, N,N-dimethylacetamide, N,N-diethyldodecanamide), ethers (e.g., tetrahydrofuran, diethyl ether), and ketones (e.g., methyl ethyl ketone, diethyl ketone, methyl isobutyl ketone, benzyl methyl ketone, benzyl acetone, diacetone alcohol, cyclohexanone, acetone, urea) are preferred. Toluene, chloroform, dichloromethane, dimethylformamide, tetrahydrofuran, methyl ethyl ketone and methyl isobutyl ketone are more preferred.

The combined concentration of the block copolymer and the water-soluble homopolymer B in the solution is preferably between 0.1 and 20 wt %, and more preferably between 0.25 and 15 wt % based on the total weight of the solution. Within this range, handleability in the subsequently described coating operation is good, enabling a uniform film to be easily obtained. The above solvents may be used singly or in combination.

The method of applying the above-described solution is not subject to any particular limitation, provided a uniform thickness and a smooth surface are achieved. Examples of methods that may be employed include spin coating, spray coating, roll coating and ink jet coating. Of these, spin coating is preferred from the standpoint of productivity.

Following the film-forming step, if necessary, the film applied in the film-forming step may be subjected to heating treatment (heating step). The heating step further enhances the degree of order of the resulting microphase-separated morphology.

This step may be carried out in a vacuum, in an inert gas atmosphere, or in an organic solvent vapor atmosphere. Removal Step

The removal step is the step of removing the water-soluble homopolymer B within the film obtained in the film-forming step (applied film) with water. This step removes only the water-soluble homopolymer B from the film applied in the film-forming step, thereby giving on the adsorbing compound layer a porous body having pores of cylindrical shape which are oriented perpendicularly to the film surface. The porous body obtained has the same structure as that obtained in Step 4.

The method of rinsing with water to remove the water-soluble homopolymer B is not subject to any particular limitation, so long as it is able to remove the water-soluble homopolymer B. For example, this may involve using a shower to spray water onto the applied film obtained in the film-forming step, or dipping the applied film obtained in the film-forming step in water. The rinsing step may be carried out a plurality of times. With regard to the rinsing time, optimal conditions are suitably selected according to the material used and other considerations.

As described above, the present invention is capable of manufacturing a structure (multilayer body) having a micropattern morphology on a flexible substrate such as a polymer substrate (film) by providing a conductive layer, an adsorbing compound layer, and an organic-inorganic composite layer on the flexible substrate. More specifically, a structure having a layer of a phase-separated morphology which is formed of different types of materials including a metal and a polymer and in which one of the materials is oriented perpendicularly to the substrate can be obtained at high definition and low cost. The present invention can use a flexible substrate such as a polymer substrate to obtain a structure having a micropattern morphology over a large surface area and at low cost, enabling the development of various applications making the most of such flexibility. Moreover, block copolymers composed of general-purpose polymers can be used, which is industrially highly beneficial.

Although the mechanism for the orientation of the microphase-separated morphology of the block copolymer has yet to be sufficiently elucidated in the literature and the detailed mechanism of operation of the present invention is not well understood, it is presumed that the use of a conductive layer and an adsorbing compound layer makes it possible to obtain substrate surface qualities (surface energy, surface roughness) suitable for perpendicular orientation.

As described above, the conductive layer also serves as the plating nucleus in the plating process for metal filling. Therefore, a metal is only filled into specified pores, whereby the structure obtained exhibits anisotropy in various properties.

Orientation of the microphase-separated morphology and filling of the metallic material can be simultaneously controlled by having the multilayer structure including the conductive layer and the adsorbing compound layer.

### EXAMPLES

Examples of the present invention are provided below by way of illustration and not by way of limitation.

Contact angle measurements in the following examples were carried out by depositing a 2 μL drop of ion-exchanged water on the film and measuring the water drop contact angle on the film surface 10 seconds later with a contact angle goniometer (DropMaster 700, manufactured by Kyowa Interface Science Co., Ltd.). Atomic force microscope (AFM) observations were carried out with a SPA-400 system (Seiko Instruments, Inc.), on the basis of which values such as the subsequently described surface roughness were measured. Scanning transmission electron microscope (STEM) observations were carried out using an HD-2300 system (Hitachi High-Technologies Corporation).

### Example 1

Copper was deposited by EB vapor deposition to prepare a copper layer with a thickness of 50 nm on a polyimide film (UPILEX-50S available from Ube Industries, Ltd.). The copper layer had a surface roughness Ra of 1.08 nm. Following vapor deposition, the film was immediately immersed in a 1.0 wt % toluene solution of methoxyphenylethylamine and allowed to stand for one day. Subsequently, the resulting film was rinsed with toluene and dried to prepare a flexible metal substrate 1 having a deposited adsorbing compound layer. The adsorbing compound layer was a monomolecular film and had a thickness as calculated by WinMOPAC (Ver.3.9.0) of about 1.1 nm. Following vapor deposition of copper, the contact angle with water was 21±4°. Following surface modification, the contact angle with water was 70±10°. The difference between the surface tension of polystyrene (PS) with the substrate and the surface tension of polymethyl methacrylate (PMMA) with the substrate was 0.26 mN/m.

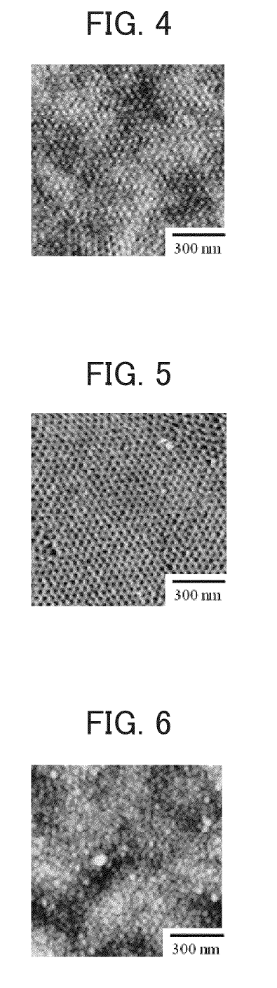

Next, a 2.5 wt % toluene solution of PS-b-PMMA (Mw of PS=35,500; Mw of PMMA=12,200; trade name: P6028-SMMA) was spin-coated (1,500 rpm, 30 seconds) onto the substrate 1 and annealed at 220° C. under an atmosphere of N₂, thereby preparing a block copolymer layer with a thickness of about 150 nm. The resulting product was called Specimen A. FIG. 4 shows a surface AFM image of Specimen A. It was confirmed from the AFM image in FIG. 4 and from TEM examination carried out for the structure in its thickness direction that a perpendicular cylindrical phase-separated morphology in which cylindrical microdomains were perpendicularly oriented had formed in the block copolymer layer. For the TEM examination, Specimen A was cut with a microtome to observe its section with reference to the literature (Polymer vol. 43, p. 2507 (2002)).

Next, Specimen A obtained in Example 1 was subjected to UV irradiation (25 J/cm²) for 180 seconds, then rinsed with acetic acid to remove the PMMA component. The resulting product was called Specimen B. FIG. 5 shows a surface AFM image of Specimen B. From FIG. 5, it was confirmed that the PMMA component had been removed and that cylindrical pores had formed in the block copolymer layer.

Then, the resulting Specimen B was immersed in the plating bath containing copper pyrophosphate of the composition shown in Table 1 to carry out electrolytic plating (current density: 1 mA/cm², treatment time: 32 seconds) to obtain Specimen C. The conductive layer in Specimen B was used as the electrode and the copper plate as the control electrode. FIG. 6 shows a surface AFM image of Specimen C obtained. The surface of the resulting Specimen C was subjected to AFM examination, which confirmed that a metal had been filled into the cylindrical pores with an average diameter of 29 nm.

TABLE 1
Composition of plating bath containing copper pyrophosphate

| Component | Content | |
|---|---|---|
| Copper pyrophosphate | 80 | g/L |
| Potassium pyrophosphate | 290 | g/L |
| Aqueous ammonia | 3 | mg/L |
| Potassium nitrate | 5 | g/L |
| Solution [water:methanol (volumetric ratio) = 8:2] | | |
| pH | 8.6 to 9.0 | |
| Bath temperature | 60° | C. |

| | |
|---|---|
| Agitation | Stirrer bar |

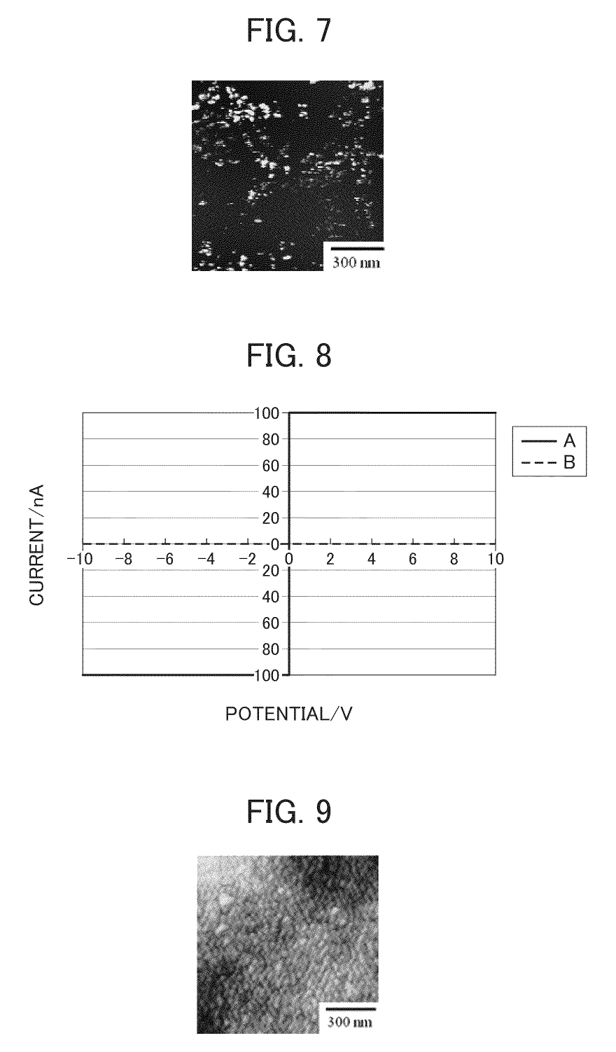

In addition, Specimen C was used to carry out AFM/current imaging. “Current imaging” refers to simultaneous current measurement made by applying an arbitrary voltage between a probe and a specimen while the surface profile of a specimen is observed. In this measurement, a larger current change with respect to a voltage change means that the current flows more smoothly. More specifically, an AFM probe was brought into contact with Specimen C by setting the conductive layer of Specimen C as one of the electrodes and the AFM probe as the other, and current-voltage (I-V curve) characteristics were determined. The results are shown in FIGS. 7 and 8.

The cylindrical portions were only imaged in the AFM current image in FIG. 7. This means that a current only flows through the cylindrical portions. In addition, it was confirmed from the I-V curve in FIG. 8 that the cylindrical portions (part A) had a considerably large change in current with respect to the voltage and that a current flowed between the electrodes very smoothly. On the other hand, it was confirmed that the current did not change at all with respect to the voltage in other portions than the cylindrical portions on Specimen C (part B) and that no current flowed at all. These results confirmed that copper had deposited only in the cylindrical pores so as to be thoroughly filled into the pores in the film thickness direction.

### Example 2

Copper was deposited by EB vapor deposition to prepare a copper layer with a thickness of 50 nm on a polyimide film (UPILEX-50S available from Ube Industries, Ltd.). The copper layer had a surface roughness Ra of 1.08 nm. Following vapor deposition, the film was immediately immersed in a 0.5 wt % toluene solution of methoxyphenylpropyltrimethoxysilane and allowed to stand for one day. Subsequently, the resulting film was rinsed with toluene and dried to prepare a flexible metal substrate 2 having a deposited adsorbing compound layer. The adsorbing compound layer was a monomolecular film and had a thickness as calculated by WinMOPAC (Ver.3.9.0) of about 1.3 nm. Following vapor deposition of copper, the contact angle with water was 21±4°. Following surface modification, the contact angle with water was 78±8°. The difference between the surface tension of polystyrene (PS) with the substrate and the surface tension of polymethyl methacrylate (PMMA) with the substrate was 0.26 mN/m.

Next, a 3.5 wt % toluene solution of PS-b-PMMA (Mw of PS=35,500; Mw of PMMA=12,200) was spin-coated (1,500 rpm, 30 seconds) onto the substrate 2 and annealed at 220° C. under an atmosphere of N₂, thereby preparing a block copolymer layer with a thickness of about 300 nm. The resulting product was called Specimen D. It was confirmed from the surface AFM image and TEM examination for Specimen D that a perpendicular cylindrical phase-separated morphology in which cylindrical microdomains were oriented perpendicularly to the substrate had formed in the block copolymer layer.

Then, the resulting Specimen D was subjected to UV irradiation (25 J/cm²) for 180 seconds, then rinsed with acetic acid to remove the PMMA component. The resulting product was called Specimen E. From the surface AFM image of Specimen E, it was confirmed that the PMMA component had been removed and that cylindrical pores had formed in the block copolymer layer.

Then, the resulting Specimen E was immersed in the plating bath containing copper sulfate of the composition shown in Table 2 to carry out electrolytic plating (current density: 1 mA/cm², treatment time: 60 seconds) to obtain Specimen F. The conductive layer in Specimen E was used as the electrode and the copper plate as the control electrode. The surface of the resulting Specimen F was subjected to AFM examination (FIG. 9), which confirmed that a metal had been filled into the cylindrical pores with an average diameter of 29 nm.

TABLE 2
Composition of plating bath containing copper sulfate

| Component | Amount of addition |
|---|---|
| Distilled water | 1069.29 g |
| Copper sulfate pentahydrate | 112.5 g |
| Conc. sulfuric acid | 285 g |
| Hydrochloric acid | 0.21 g |

Specimen F was used to carry out AFM/current imaging by the same method as in Example 1. The measurement results confirmed that copper had deposited only in the cylindrical pores so as to be thoroughly filled into the pores in the film thickness direction.

What is claimed is:

1. A structure comprising in order on a flexible substrate:
a conductive layer;
an adsorbing compound layer formed of a compound having a group which is adsorbable onto the conductive layer; and
an organic-inorganic composite layer having a microphase-separated morphology which includes a polymer phase and a metal phase and in which one of the phases makes up cylindrical or lamellar microdomains oriented perpendicularly to the flexible substrate.

2. The structure of claim 1, wherein the adsorbing compound layer has a thickness which is equal to or larger than a surface roughness Ra of the conductive layer.

3. The structure of claim 1, wherein the adsorbing compound layer is a layer formed of a compound represented by general formula (1):
X—L—R General formula (1)
wherein R is a hydrogen atom, an optionally branched alkyl group or an alkoxy group, L is a divalent linkage group or merely a bond, X is a thiol group, an amino group, a selenol group, a nitrogen-containing heterocyclic group, an asymmetric or symmetric disulfide group, a sulfide group, a diselenide group, a selenide group or —Si(R¹)ₘ(Y)ₙ, R¹ is a hydrogen atom or an alkyl group of 1 to 6 carbon atoms, Y is a hydrolyzable group, and the letter m is an integer from 0 to 2 and the letter n is an integer from 1 to 3, such that n+m=3.

4. The structure of claim 1, wherein the conductive layer is a layer comprising at least one metal or semimetal selected from the group consisting of gold, platinum, silver, copper, iron, silicon, nickel, lead, indium, chromium, tin, titanium, zinc, gallium, bismuth, zirconium and aluminum, or an oxide thereof.

5. The structure of claim 1, wherein a metal making up the metal phase of the organic-inorganic composite layer is at least one metal selected from the group consisting of copper, silver, gold, and aluminum.

6. The structure of claim 1, wherein the flexible substrate is a polymer substrate.

7. The structure of claim 1, wherein a polymer making up the polymer phase of the organic-inorganic composite layer is a polymer selected from the group consisting of polystyrene, polymethyl methacrylate, polybutadiene, polyisoprene and polyethylene oxide.

8. A method of manufacturing a structure comprising:
a step 1 for forming a conductive layer on a flexible substrate;
a step 2 for forming an adsorbing compound layer on the conductive layer using an adsorbing compound;
a step 3 for forming on the adsorbing compound layer a block copolymer layer made of a block copolymer and having a microphase-separated morphology in which one of phases is a lamellar or cylindrical phase oriented perpendicularly to the flexible substrate;
a step 4 for removing one of the phases in the microphase-separated morphology after the step 3; and
a step 5 for filling a region of the removed phase with a metal after the step 4.

9. The method of claim 8, wherein the step 5 is a step of depositing the metal in the region of the removed phase by electrolytic plating or electroless plating.

10. The method of claim 8, wherein the step 3 is a step of forming the block copolymer layer by coating the adsorbing compound layer with a solution containing the block copolymer.

11. The method of claim 8, wherein one of two types of polymer chains making up the block copolymer is a polymer chain selected from the group consisting of polystyrene, polymethyl methacrylate, polybutadiene, polyisoprene and polyethylene oxide.
